(19) United States
(12) Patent Application Publication
(10) Pub. No.: US 2020/0320518 A1
(43) Pub. Date: Oct. 8, 2020

(54) ARCHITECTURE FOR FACILITATING DATA TRANSFER FOR BLOCKCHAIN-BASED UNITS IN PACKET-BASED SYSTEMS

(71) Applicant: Parachute Wallet LLC, Brooklyn, NY (US)

(72) Inventors: Shawn Simas, Kitchener (CA); Lindsey Winder, Brooklyn, NY (US); Alexander Michelsen, New York, NY (US)

(21) Appl. No.: 16/830,188

(22) Filed: Mar. 25, 2020

Related U.S. Application Data
(60) Provisional application No. 62/828,246, filed on Apr. 2, 2019.

(51) Int. Cl. G06Q 20/36; H04L 9/06; G06Q 20/32; H04L 12/58

(52) U.S. Cl. CPC G06Q 20/3678; H04L 9/0637; H04L 51/046; G06Q 20/3223; G06Q 20/3674

(57) ABSTRACT

Computer architecture for facilitating data transfer between a packet-based system and a blockchain-based system may include a computing server having interfaces and parsing tools for processing data packets transmitted from the packet-based system. The computing server maintains a plurality of blockchain-based units that are connected to the computing server's cryptographic public keys. The computing server may parse the text messages to identify a text string that matches a defined action keyphrase. The computing server stores new data associated with a user that is related to the text message. The new data reflects a change in a blockchain-based unit in accordance with an action corresponding to the defined action keyphrase. The computing server transmits a confirmation to the user. The blockchain-based unit remains connected to the public cryptographic keys of the computing server during storing of the new data and transmission of the confirmation.

### CROSS-REFERENCE TO RELATED APPLICATION

The present application claims the benefit of U.S. Provisional Patent Application 62/828,246, filed on Apr. 2, 2019, which is hereby incorporated by reference in its entirety.

### TECHNICAL FIELD

The disclosure generally relates architecture that facilitates data transfer related to blockchain-based units using packet-based systems.

### BACKGROUND

A blockchain may include a chain of data blocks that are linked together through hashes of previous blocks. The data stored in an intermediate block is often immutable, thus offering advantages over conventional database systems. Various participants in a decentralized blockchain system may independently validate the data stored in the blockchain by tracing through the history of the data. As a result, blockchains often offer greater transparency, enhanced security, and improved traceability than centralized systems. However, blockchain systems are not without drawbacks. For example, blockchains are often associated with a slow block-generation time. The confirmation of data could even be slower because parties often wait until additional subsequent blocks are generated to consider that data stored in a block is confirmed. For example, many computers and network systems operate under the packet framework. Blockchains' slow confirmation speed makes the blockchains difficult to be integrated with packet-based systems.

### SUMMARY

Embodiments relate to a computer architecture including a computing server that facilitates data transfer of blockchain-based units between devices that communicate through a packet-based system. The computing server maintains blockchain-based units in one or more blockchain. The blockchain-based units are connected to the cryptographic public keys of the computing server.

Client devices may request the computing server to perform actions that are related to one of the blockchain-based units. The request may take the form of a command included in a message transmitted between client devices through a packet-based system. The packet-based system transmits data packets that include the messages to the computing server. The computing server parses the messages to identify a string that matches a defined action keyphrase. The computing server may also identify the blockchain-based unit related to the messages. By parsing the relevant information, the computing server determines whether a command is valid. If the command is valid, the computing server stores new data associated with a user who is related to the messages. The new data reflects a change in the blockchain-based unit in accordance with an action corresponding to the defined action keyphrase. The computing server transmits, through the packet-based platform, a confirmation of the change to the user. During the storage of the new data and transmission of the confirmation, the blockchain-based unit remains connected to one or more of the cryptographic public keys of the computing server.

### BRIEF DESCRIPTION OF THE DRAWINGS

(FIG.) 1 illustrates a system environment of an example computing server, in accordance with an embodiment.

FIG. 2 is a block diagram illustrating various components of a computing server, in accordance with an embodiment.

FIG. 3 is a flowchart depicting an example process of completing a transaction by a computing server, in accordance with an embodiment.

FIG. 4A is a conceptual diagram illustrating an example screenshot of a graphical user interface, in accordance with an embodiment.

FIG. 4B is a conceptual diagram illustrating a second example screenshot of a graphical user interface, in accordance with an embodiment.

FIG. 5A is a flowchart depicting an example process of using a retained blockchain address in a first blockchain, in accordance with an embodiment.

FIG. 5B is a flowchart depicting an example process of using a retained blockchain address in a second blockchain, in accordance with an embodiment.

FIG. 6 is a flowchart depicting an example process of performing a centralized process using decentralized units, in accordance with an embodiment.

FIG. 7A is a block diagram illustrating a chain of transactions recorded on a blockchain, in accordance with an embodiment.

FIG. 7B is a block diagram illustrating a connection of multiple blocks in a blockchain, in accordance with an embodiment.

FIG. 8 is a block diagram illustrating an example computing device, in accordance with an embodiment.

The figures depict, and the detail description describes, various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### System Overview

FIG. (FIG. 1 is a block diagram that illustrates a system environment 100 of an example computing server, in accordance with an embodiment. By way of example, the system environment 100 includes one or more user devices, e.g., 110A, 110B, 110C, etc., a computing server 130, a data store 135, one or more messaging platforms 140A, 140B, etc., and one or more blockchains 150A, 150B, etc. The entities and components in the system environment 100 communicate with each other through the network 160. In various embodiments, the system environment 100 may include different, fewer, or additional components. The components in the blockchain system environment 100 may each correspond to a separate and independent entity or may be controlled by the same entity. For example, in one embodiment, the computing server 130 may control the data store 135. In another embodiment, the computing server 130 is part of the messaging platform 140. In yet another embodiment, the computing server 130, the data store 135, and the messaging platform 140 are controlled by different entities.

User devices 110A, 110B, 110C may collectively be referred to as user devices 110 or a user device 110. User devices 110 may also be referred to as client devices. A user device 110 may be controlled by a user who may or may not have an account with the computing server 130. The user devices 110 may be any computing device. Examples of user devices 110 include personal computers (PC), desktop computers, laptop computers, tablet computers, smartphones, wearable electronic devices such as smartwatches, or any other suitable electronic devices. The users controlling the user devices 110 may communicate with each other through the messaging platform 140.

The user devices 110A, 110B, and 110C each may respectively include a user interface 115A, 115B, or 115C (collectively referred to as interfaces 115 or an interface 115). A user interface 115 communicates with the computing server 130 and is run at a user device 110. The user interfaces 115 allow the users to perform various actions associated with services provided by the computing server 130. The user interface 115 may take different forms. In one embodiment, the user interface 115 is a software application interface that is provided and controlled by the computing server 130. For example, the computing server 130 provides a front-end software application that can be displayed at a user device 110. In one case, the front-end software application is a software application that can be download and installed at user devices 110 via, for example, an application store (App store) of the user device 110. In another case, the front-end software application takes the form of a webpage interface of the computing server 130 that allows clients to perform actions through web browsers. The front-end software application includes a graphical user interface (GUI) that displays various information and graphical elements. In another embodiment, user interface 115 does not include graphical elements but communicates with the computing server 130 via other suitable ways such as command windows or application program interfaces (APIs).

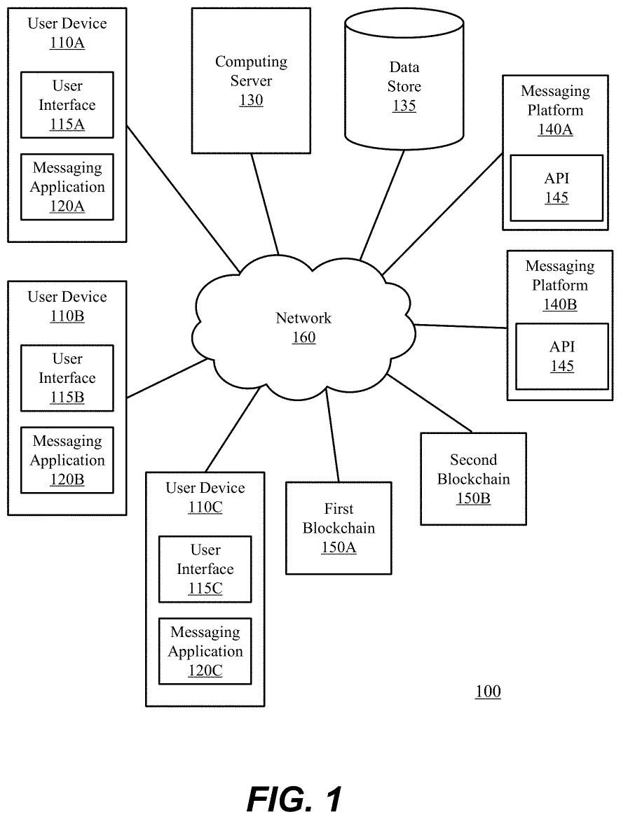

A computing server 130 may be a centralized server that provides various blockchain-based operations for the users. The services provided by the computing server 130 may include digital wallet, asset exchange, asset deposit, blockchain management, smart contract generation, and data feed. In one embodiment, the computing server 130 may be partially centralized and partially decentralized. For example, certain transactions occurred through the computing server 130 or through the messaging platform 140 may be centralized. The computing server 130 may also provide blockchain-based unit transactions that are decentralized or that rely on a decentralized blockchain. The detail of the operations and sub-components of the computing server 130 will be further discussed in association with FIG. 2.

The data store 135 includes one or more storage units such as memory that takes the form of non-transitory and non-volatile computer storage medium to store various data. The computer-readable storage medium is a medium that does not include a transitory medium such as a propagating signal or a carrier wave. In one embodiment, the data store 135 communicates with other components by the network 160. This type of data store 135 may be referred to as a cloud storage server. Example cloud storage service providers may include AMAZON AWS, DROPBOX, RACKSPACE CLOUD FILES, AZURE BLOB STORAGE, GOOGLE CLOUD STORAGE, etc. In another embodiment, instead of a cloud storage server, the data store 135 is a storage device that is controlled and connected to the computing server 130. For example, the data store 135 may take the form of memory (e.g., hard drives, flash memory, discs, ROMs, etc.) used by the computing server 130 such as storage devices in a storage server room that is operated by the computing server 130.

Messaging platforms 140A and 140B may collectively be referred to as messaging platforms 140 or a messaging platform 140. A messaging platform 140 is a server that provides messaging service to any users. A messaging platform 140 allows one or more users to participate in any number of conversations with others, such as in the form of private chats, group chat, chatrooms, forums, etc. The conversations between users may take the form of text messages, image messages, voice messages, video conferences, etc. Text messages may include text strings using alphabetical letters, numbers, foreign letters and characters, and other suitable text. Text messages may also include other symbols, graphics, ideograms such as EMOJI, customized image messages, etc. The messaging platforms 140 may also be referred to as packet-based platforms that use Internet packets to exchange messages and may also be referred to as social media platforms. The messaging platforms 140 may take different forms. In one case, a messaging platform 140 may take the form of an instant messaging platform such as WHATSAPP, TELEGRAM, SLACK, WECHAT, LINE, FACEBOOK MESSENGER, SNAPCHAT, GOOGLE HANGOUTS, SKYPE, etc. In another case, a messaging platform 140 may take the form of an email server, a comment platform, blogging, microblogging, a forum, a social networking system, a news aggregation system that allows users to comment, etc. In yet another case, a messaging platform 140 may take the form of a server for other services that are not primarily for communications but also provide the messaging functionality for users.

A messaging platform 140 may publish a messaging application 120 (such as messaging application 120A, 120B, or 120C) that is installed in a user device 110 for the user to send and receive messages. Various messaging platforms 140A, 140B, etc. can have different messaging applications 120 installed at one or more user devices 110. A messaging platform 140 may also include API 145 for third parties to develop embedded applications within the messaging platform 140. For example, the company operating the computing server 130 may develop an application that runs inside a messaging platform 140A. While only two messaging platforms 140 are shown in FIG. 1, system 100 may include zero to multiple messaging platforms 140.

The system environment 100 may include one or more blockchains 150A, 150B, etc. (collectively referred to as blockchains 150 or a blockchain 150). A blockchain 150 may be a public blockchain that is decentralized. A public blockchain network includes a plurality of nodes that cooperate to verify transactions and generate new blocks. In some implementations of a blockchain, the generation of a new block may also be referred to as a mining process. Some of the blockchains 150 support smart contracts, which are set of code instructions that are stored on a blockchain 150 and are executable when one or more conditions are met. When triggered, the set of code instructions may be executed by a computer such as a virtual machine of the blockchain 150. Here, a computer may be a single operation unit in a conventional sense (e.g., a single personal computer) or may be a set of distributed computing devices that cooperate to execute the code instructions (e.g., a virtual machine or a distributed computing system). A blockchain 150 may be a blockchain that is developed by the computing server 130 or a messaging platform 140 or may be an existing blockchain such as BITCOIN, ETHEREUM, EOS, NEO, CARDANO, STELLER, etc.

The communications among the user devices 110, the computing server 130, the messaging platforms 140, and blockchains 150 may be transmitted via a network 160, for example, via the Internet. In one embodiment, the network 160 uses standard communications technologies and/or protocols. Thus, the network 160 can include links using technologies such as Ethernet, 802.11, worldwide interoperability for microwave access (WiMAX), 3G, 4G, LTE, 5G, digital subscriber line (DSL), asynchronous transfer mode (ATM), InfiniBand, PCI Express Advanced Switching, etc. Similarly, the networking protocols used on the network 160 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 160 can be represented using technologies and/or formats including the hypertext markup language (HTML), the extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. The network 160 also includes links and packet switching networks such as the Internet.

### Example Computing Server

FIG. 2 is a block diagram representing an example computing server 130, in accordance with an embodiment. In the embodiment shown in FIG. 2, the computing server 130 includes messaging platform interfacing engine 210, blockchain interfacing engine 215, cryptographic key management engine 220, account store 225, digital wallet store 230, central ledger system 235, asset exchange engine 240, asset management engine 245, front-end interface 250, communication terminals 255, smart contract engine 260, and oracle machine 265. The functions of the computing server 130 may be distributed among different components in a different manner than described below. Also, in various embodiments, the computing server 130 may include different, fewer, and/or additional components.

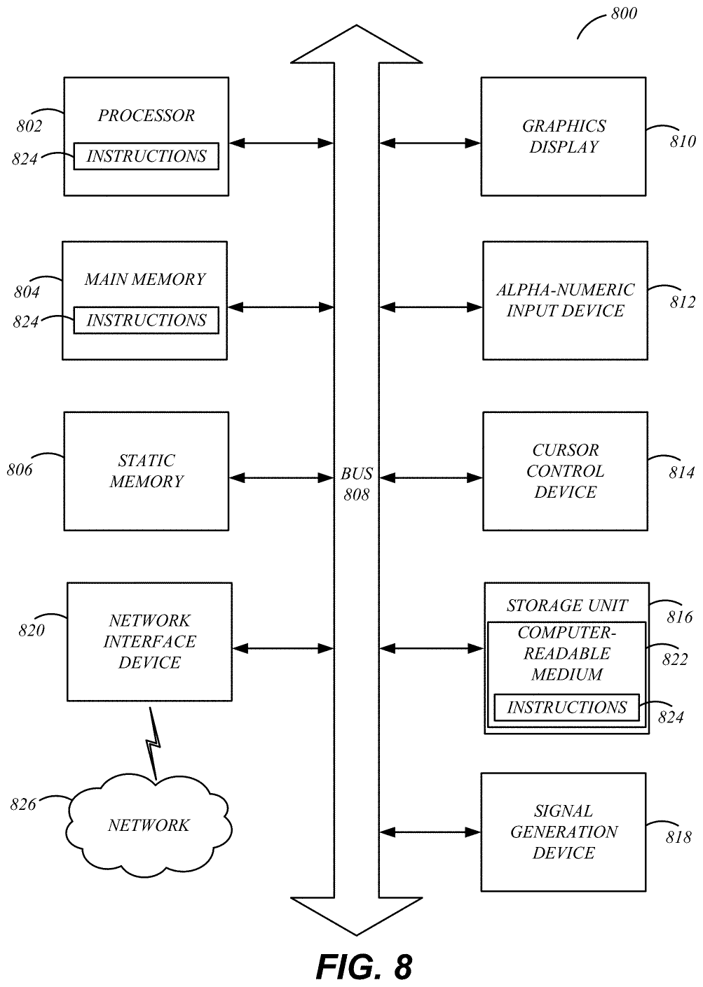

While the computing server 130 is used in a singular form, the computing server 130 may include one or more computers that include one or more processors and memory. The memory may store computer code that includes instructions. The instructions, when executed by one or more processors, cause the processors to perform one or more processes described herein. The computing server 130 may take different forms. In one embodiment, the computing server 130 is a single computer that executes code instructions directly. In another embodiment, the computing server 130 is a group of computing devices that communicate with each other. The computing devices may be located geographically at the same (e.g., a server room) or different locations. In yet another embodiment, the computing server 130 includes multiple nodes that operate in a distributed fashion such as in cloud computing or distributed computing. Each node may include one or more computing devices operating together. In some cases, the computing server 130 may also include virtual machines. Any computing devices, nodes, virtual machines, singular or plural, may simply be referred to as a computer, a computing device, or a computing server. Components of the computing server 130 shown in FIG. 2, individually or in combination, may be a combination of hardware and software and may include all or a subset of the example computing system illustrated and described in FIG. 8.

The messaging platform interfacing engine 210 acts as an interface between one or more messaging platforms 140 and the computing server 130 to allow computing server 130 to perform various actions based on commands that are sent by users from the messaging platforms 140. The commands sent by the users from the messaging platforms 140 may take the form of instructions that are generated from users interacting with one or more control elements of messaging applications 120. The commands may also take the form of text messages that are intended to be sent to the computing server 130. The commands may also take the form of text messages that are sent to another user in a conversation between two or more users. The messaging platform interfacing engine 210 includes a parsing tool to identify commands in the form of keyphrases embedded in the conversation. Other forms of commands are also possible. The messaging platform interfacing engine 210, based on the command received and/or identified, transmits the command to another component of computing server 130 to perform one or more actions in accordance with the command.

The messaging platform interfacing engine 210 monitors conversations between one or more users in messaging platforms 140. For example, users in a group chat or a private conversation may grant permission for the computing server 130 to monitor the conversation in order for certain services provided by the computing server 130 to be enabled in the messaging conversation. The computing server 130 can monitor a conversation in different ways. For example, the computing server 130 can be one of the members in the conversation (whether the presence of the computing server 130 is visible or not) so that the messaging platform interfacing engine 210 can receive data packets that include the messages of the users. In another embodiment, the messaging platform interfacing engine 210 can monitor the conversation by having the messaging platform 140 to forward the data packets that includes the messages to the messaging platform interfacing engine 210. For example, a conversation among users may be carried out in or with an embedded application developed by the computing server 130 in the messaging platform 140. The messaging platform 140 forwards the data packets to the messaging platform interfacing engine 210 via an API.

Upon users' authorization, the messaging platform interfacing engine 210 receives messages logs of conversations and metadata related to the message logs from one or more messaging platforms 140. The message logs may take different forms. In one case, the message log is in the form of real-time conversation and is updated almost instantly as the users send messages. In another case, the message logs are sent in batches for every predetermined period of time. Other ways to generate a message log is also possible. A message log may contain text strings of a conversation. The messaging platform interfacing engine 210 also receives metadata related to a message log. The metadata may include a conversation identifier, a message identifier for each message, timestamps of the messages, and other fields that may identify a sender of each message, connections between messages (such as a first message quoting the second message), and other information related to the messages in the message log. The metadata may also include metadata tags that group messages into different categories based on users' definitions or message platform's definitions.

The messaging platform interfacing engine 210 including a parsing tool that scans through messages in message logs to identify text strings that match keyphrases that may be defined by the computing server 130. The keyphrases may be referred to as defined action keyphrases. Each action keyphrase includes one or more words, alphabets, numbers, and/or symbols that are arranged in a predefined manner. For example, an example action keyphrase is in the format of slash immediately followed by a word, such as “/transfer.” Each action keyphrase corresponds to an action that is defined by computing server 130. Example actions will be discussed in further detail. Using the parsing tool, messaging platform interfacing engine 210 identifies messages that include action keyphrases and determines, for each message identify, whether the message includes other information that forms a valid command for the computing server 130 to carry out the action corresponding to the action keyphrase. In response to a valid command is found, the messaging platform interfacing engine 210 forwards the command to other components of the computing server 130 to carry out the action specified in the command.

The messaging platform interfacing engine 210 may monitor messages in more than one messaging platform 140. In one embodiment, users from different messaging platforms 140 can perform cross-platform actions through the computing server 130.

The blockchain interfacing engine 215 provides various functionalities for the computing server 130 to perform activities on different blockchains 150 that may have their own standards and protocols. The computing server 130 may serve as a node of a blockchain 150 to participate in the mining and data validation process. The blockchain interfacing engine 215 allows computing server 130 to broadcast various transactions to a blockchain network for recordation. The blockchain interfacing engine 215 also routinely checks new blocks generated in various blockchains to check whether pending blockchain transactions or actions have been confirmed on the blockchains 150. The blockchains 150 may include public blockchains, consortium blockchains, private blockchains. The degree of decentralization of various blockchains 150 may vary. In one embodiment, the computing server 130 may set the standard and publish its own blockchain 150 that allows the public to participate in the blockchain network.

The cryptographic key management engine 220 stores and manages one or more keys of the computing server 130 to allow the computing server 130 to participate in various blockchains and to provide validation, verification, and authentication information of the computing server 130 for other nodes in the blockchains 150. For example, the cryptographic key management engine 220 stores various cryptographic private keys of the computing server 130. For each blockchain 150, the computing server 130 maintains one or more private keys to allow the computing server 130 to generate blockchain addresses of the computing server 130 and to validate that computing server 130 owns the blockchain-based units that are connected to one or more cryptographic public keys of the computing server 130. In various embodiments, a blockchain address of the computing server 130 may be generated by a series of one or more one-way functions from the public key, which is generated from the private key. In some embodiments that are associated with certain types of blockchains such as BITCOIN, the computing server 130 may generate a new private key for each user to generate a blockchain address of the computing server 130 specifically the repeated deposit transactions of the user. The cryptographic key management engine 220 derives a blockchain addresses by hashing the public key, adding prefixes, suffixes, and/or versions to the hash or the public key, creating a checksum, and/or encoding a derived result. By way of a specific example, a cryptographic key management engine 220 may start with a private ECDSA key and generates a public key based on the private key. The cryptographic key management engine 220 performs a SHA-256 hash on the public key and performs a RIPEMD-160 hash on the derived result of the SHA-256 hash. The cryptographic key management engine 220 adds a version byte in a header location of the RIPEMD-160 hash. The addition of a version byte allows the cryptographic key management engine 220 to generate many blockchain addresses based on the same public key. The cryptographic key management engine 220 creates a checksum of the versioned RIPEMD-160 hash and add the checksum to the hash. The hash with the checksum may further be encoded to become the blockchain address for the computing server 130. Any parties in a blockchain network can verify that the blockchain address matches the public key. Hence, a blockchain-based unit that is sent or held by the blockchain address is also connected to the public key of the computing server 130.

The account store 225 maintains user data related to various user accounts. The account store 225 may correspond to the data store 135. The user data stored in the account store 225 may include profile data of the users and unique user identifiers that are used in various messaging platforms 140. A unique user identifier may be username in a messaging platform 140 or a unique identifier that is normally not visible to the user to keep track of a unique individual in case of a username change. The account store 225 maintains the association between various unique identifiers in different messaging platform 140 and a user account so that the computing server 130 can keep track of the mapping of a user account to a user in a messaging platform 140.

The digital wallet store 230 keeps track of various blockchain-based units or other units that are associated with a user account. Example blockchain-based units may include various blockchain tokens such as PARACHUTE TOKEN (PAR) and various cryptocurrencies such as BITCOIN, DOGECOIN, ETHER, RIPPLE, LITECOIN, and EOS. Other example units may include fiat currencies, commodities, futures, securities, collaterals, and other suitable assets. In some cases, a user may also choose to participate in a central ledger system. In other cases, a user may prefer to keep her own blockchain-based units in her own blockchain address. The digital wallet store 230 may also help users to maintain their own blockchain-based units. For example, the digital wallet may store a cryptographic private key for a user. The private key allows the user to broadcast transactions and take actions in a blockchain and proves that the user is the owner of a certain quantity of blockchain-based units recorded on a blockchain.

In one embodiment, the computing server 130 uses a central ledger system 235 to keep track of user's balances of various blockchain-based units or other units in a user account. The computing server 130 maintains a centralized asset pool to keep various blockchain-based units in a centralized manner. For example, an individual user may own a certain quantity of a blockchain-based unit in her account. The quantity of the blockchain-based unit may be kept in the centralized asset pool instead of in the individual user's own blockchain address. Put differently, for users who participate in the asset pool, the blockchain-based units in each of the user accounts are connected to one or more cryptographic public keys of the computing server 130. The computing server 130 acts as a fiduciary to hold the pool of assets in its own blockchain address. The computing server 130 uses the central ledger system 235 to keep track of individual balances of various blockchain-based units with respect to a particular user. This type of account information may also be stored in the account store 225. When there is a change in a user's balance, the computing server 130 stores new data associated with the user. The new data reflecting a change in a particular blockchain-based unit. In some cases that are associated with a certain type of blockchains, the computing server 130 may use a single private key (and one corresponding public key) to control the blockchain-based units in the central ledger system 235 in a blockchain. In other cases that are associated with another type of blockchains, the computing server 130 may have multiple different private keys (and multiple public keys) to control the blockchain-based units in the central ledger system 235 in a blockchain. In other words, same type of blockchain units that are associated with different public keys are considered by the central ledger system 235 as a single pool. The central ledger system 235 manages the pool that may or may not be associated with different public keys for the overall balance.

Users may perform asset exchanges with other users in the computing server 130 or with individuals outside of the computing server 130. The users may perform exchanges between blockchain-based units, fiat currencies, and other assets. The asset exchange engine 240 allows at least two types of transactions. First, the transaction can be conducted in a centralized manner through the central ledger system 235 maintained by the computing server 130 to allow largely fee-less and instant transactions. For example, a first user may initiate a transfer of a blockchain-based unit to a second user via a message in a messaging platform 140. The computing server 130 saves new data reflecting changes in balances of the first user and of the second user in the central ledger system 235 while maintaining the ownership of the blockchain-based unit in the asset pool. In other words, the blockchain-based unit is not transferred on the blockchain and remains connected to one or more public keys of the computing server 130 in the blockchain 150 when the central ledger system 235 saves new data that reflects the transfer. Because new data can be created and saved relatively easily without an actual transaction in the blockchain, the first type of transaction is largely without fee and instant.

A second type of transaction is a blockchain transaction. For example, if a user intends to transfer a blockchain-based unit to another party in a blockchain network, the computing server 130 broadcasts a transaction to the blockchain network and waits for the transaction to be recorded in one of the newly generated blocks. The second type of transaction may be associated with a fee as part of the cost to generate a new block. The second type of transaction may also not be largely instant because the computing server 130 may need to wait for the generation of a new block through a blockchain mining process to confirm that the transaction is settled.

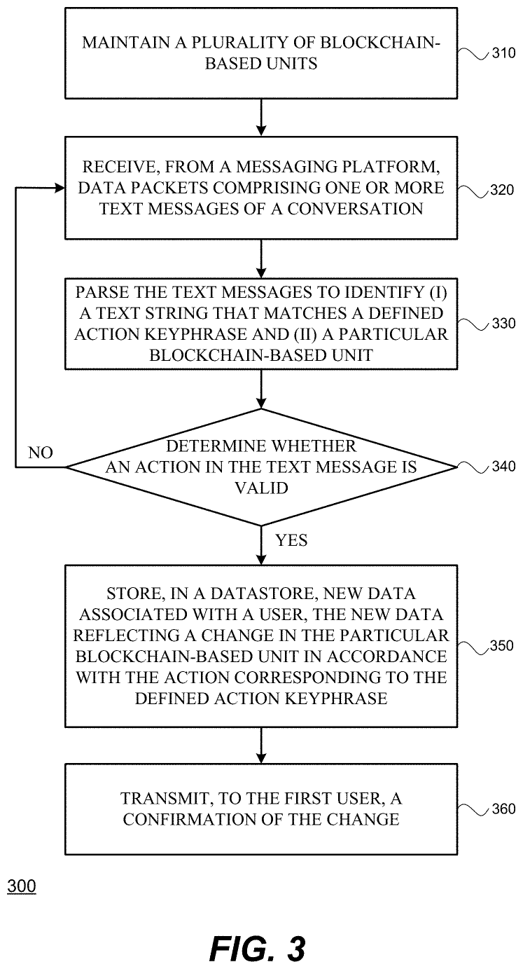

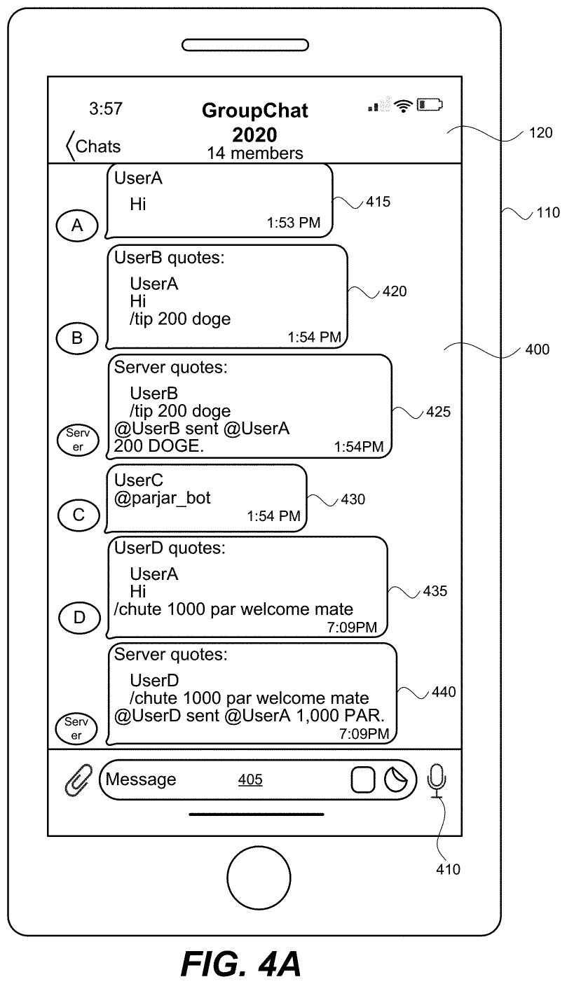

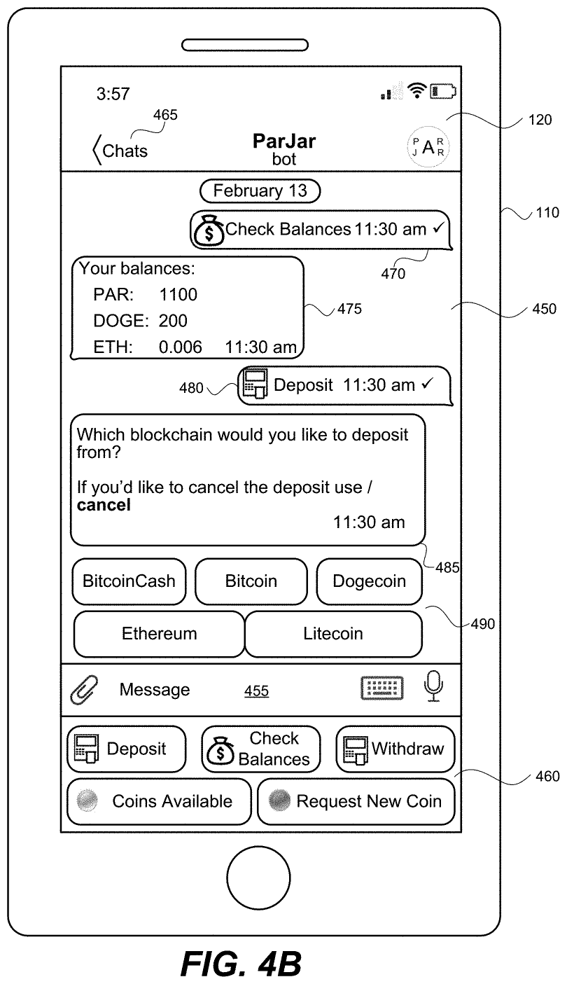

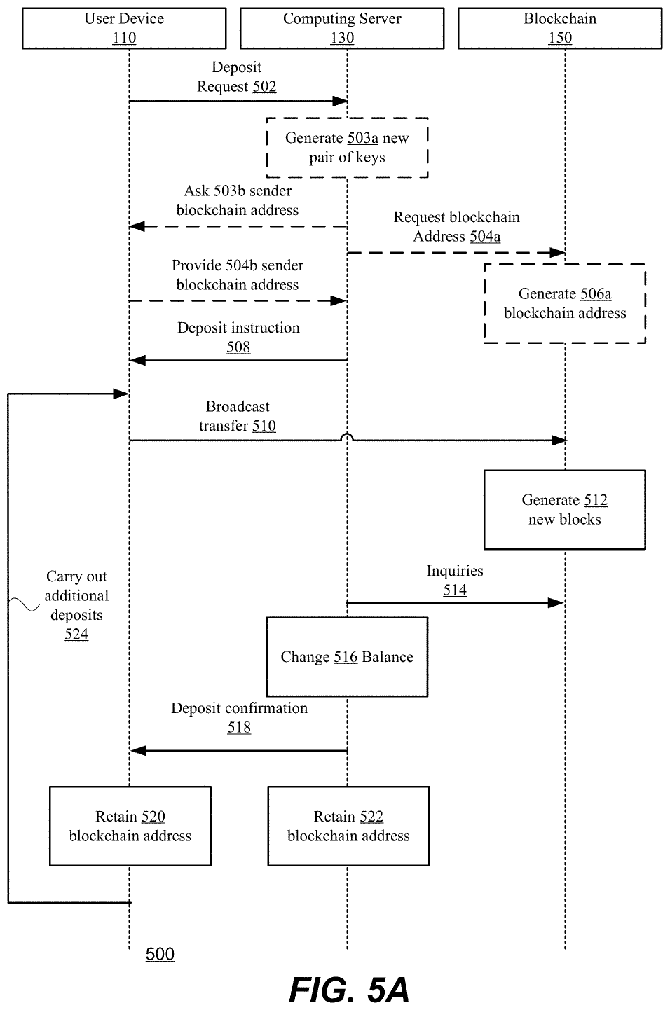

The asset management engine 245 allows users to deposit and redeem blockchain-based units and other assets to or from the computing server 130. Detail of the deposit and redeem processes in various embodiments are further discussed with reference to FIGS. 5A and 5B. After a deposit process has completed, balances are recorded in the central ledger system 235 and then allocated to each individual's subledger balances based on their deposit and other transactions within the centralized system of computing server 130. Information of the balances can be found in account store 225 and digital wallet store 230. In one embodiment, users can view the balances collectively with each balance being displayed in a summarized fashion in a messaging application 120. An example of this feature will be shown in FIG. 4B.

The computing server 130 may include one or more front-end interfaces 250. A front-end interface 250 allows users to manage their accounts, initiate transactions such as by placing a purchase or sell order and perform various blockchain-related activities. A first example of front-end interface 250 is an embedded application in a messaging platform 140 that allows users to perform actions through messages. A second example of front-end interface 250 is a software application interface that is installed on users' mobile devices such as smartphones and computers. A third example front-end interface 250 is a webpage interface of the computing server 130 that allows users to manage their accounts through web browsers. A fourth example front-end interface 250 is an application program interface (API) of the computing server 130 that allows users to initiate various transactions through program codes and algorithms.

The communication terminals 255 of the computing server 130 provide network and blockchain connections between the computing server 130 and various entities that communicate with the computing server 130. The computing server 130 may serve as a node of various public blockchains to participate in various mining and block validation processes. When the computing server 130 initiates various through a blockchain, the blockchain interfacing engine 215 broadcast transactions using the public key of the computing server 130 or the public key of users to the network of the blockchain for recordation. The broadcast transactions are recorded in one or more newly generated blocks in the blockchain and are verified after multiple subsequent blocks are linked to the block that records the transactions. The computing server 130 may include different terminals such as blockchain terminal, asset exchange terminal, messaging application terminal. Each terminal may manage a data feed or a webpage that publishes information regarding the related services and server status. Each terminal may also include its individual API.

The smart contract engine 260 manages the generation and triggering of various smart contracts that are recorded on different blockchains. A smart contract may be created through a particular programming language that is compatible with a blockchain 150. A smart contract is recorded on a block of the blockchain and may be immutable. The recorded smart contract may include executable code instructions that are triggered by a certain condition. When the condition is met and verified, the code instructions are executed by a computer to automatically execute the contract terms that take the form of code instructions. The computer that executes the smart contract may take various forms. For example, a computer described herein may be a conventional personal computer, a virtual machine for the blockchain, or even a collection of distributed nodes in distributed computing. When the code instructions of the smart contract are executed, the code instructions may cause certain events (e.g., a transaction, a generation of a token, creation of new information) to be recorded on a blockchain. The smart contract engine 260 may generate different smart contracts to be recorded on blockchains. The smart contract engine 260 may also cause the triggering of various recorded smart contracts when conditions are met.

The oracle machine 265 may serve as a data feed for one or more smart contracts. The oracle machine 265 may receive different data from various sources. For example, different parties may provide information and data to the oracle machine 265. When relevant information is obtained by the oracle machine 265, some code instructions of the smart contract may be triggered if certain conditions are met.

While a computing server 130 is shown as a component separate from a messaging platform 140, the computing server 130 may also be part of the messaging platform 140. In other words, the processes described in this disclosure may also be performed by a messaging platform 140.

### Example Message Platform Based Actions

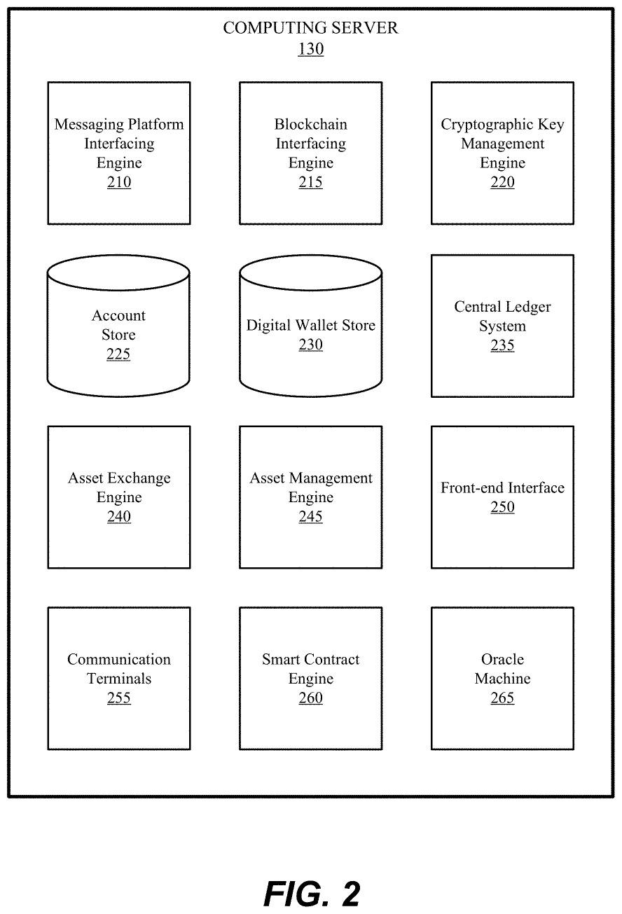

FIG. 3 is a flowchart depicting an example process of a computing server 130 performing an action based on an action keyphrase parsed from messages in a messaging platform 140, in accordance with an embodiment. A computing server 130 maintains 310 a plurality of blockchain-based units. For example, the blockchain-based units may be maintained as a pool in the central ledger system 235. In one embodiment, the blockchain-based units are connected to one or more cryptographic public keys of the computing server 130 in one or more blockchains. In other words, a blockchain-based unit is recorded on a block of a blockchain that indicates that the blockchain-based unit is tied to a blockchain address that is derived by a cryptographic public key of the computing server 130 so that the computing server 130 owns the blockchain-based unit. Users of the computing server 130 deposit their blockchain-based units to the computing server 130 by broadcasting transactions to blockchain networks to transfer the blockchain-based units to the blockchain addresses of the computing server 130. The computing server 130 may act as fiduciary hold the blockchain-based units under the pool. Other non-blockchain based units may also be transferred to the computing server 130 and be kept as part of a larger pool.

The computing server 130 uses a central ledger system 235 to store data in a data store to reflect the balances of various blockchain-based units and other units. For example, the computing server 130 stores different user accounts. Each user account includes balances of one or more blockchain-based units with respect to a particular user. The blockchain-based units in each of the user accounts may be held by the computing server 130 and be connected, in one or more blockchains, to one or more cryptographic public keys of the computing server 130.

The computing server 130 monitors various conversations of users in one or more messaging platforms 140. For example, the computing server 130 receives 320, from a messaging platform 140, data packets that include one or more messages of a conversation. The messages may be text messages or other types of messages such as voice messages, video messages, etc. The conversation may be between two or more users such as a one-to-one conversation between a first user and a second user. The conversation may also be a group chat. In some cases, the conversation may include a single user talking to a messaging platform 140 by sending commands to the messaging platform 140 as a form of text messages or other types of messages. For example, a first user may transmit messages at the account page of the first user in the messaging platform 140. The account page may be accessible only by the first user. At the account page, the first user may send text messages as commands that ask the computing server 130 to take actions related to a second user who is not in the conversation or not a recipient of the message. The computing server 130 may receive 320 the data packets via an API of the messaging platform 140 such as long polling, webhook, or push notifications. In some cases, the computing server 130 has an account at a messaging platform 140. The monitoring of conversation may be enabled by the users by including the account of the computing server 130 as one of the participants in a conversation so that the computing server 130 becomes one of the recipients of messages in the conversation.

The computing server 130 parses 330 the messages in the received data packets to identify (i) one or more text strings that match a defined action keyphrase and (ii) a unit mentioned in the messages. The parsed messages may be text messages and the unit may be a blockchain-based unit. In other embodiments, the parsed messages may also be other types of non-text messages such as a voice message that is parsed by automatic speech recognition. In a conversation, users may transmit multiple messages that may or may not be relevant to the computing server 130. The computing server 130 attempts to identify action keyphrases that are present in the messages by scanning through the messages to attempt to identify one or more action keyphrases. The action keyphrases may have a predefined format. For example, the action keyphrases may be in the format “/[command]” such as “/tip,” “/send” or “Ibid.” Other signifying start symbol or end symbol may also be used. In some cases, a keyphrase includes a single word. In some embodiments, no special character is used in the action keyphrases. In some cases, a keyphrase does not include a word. Instead, the keyphrase uses only numbers, symbols, or combinations of numbers and symbols. The computing server 130 may store a look-up table or other data that identify the mapping of the action keyphrases and each of their corresponding action to be performed by the computing server 130.

The computing server 130 may define different types of actions that are carried out by the computing server 130. In a first example, an action is a transfer of a quantity of a blockchain-based unit from a first user to a second user. A user may use the keyphrase “/send” or another similar keyphrase to initiate the action. The type of transfer depends on the keyphrase used. In one case, using the keyphrase “/send” allows the user to transfer a quantity of a blockchain-based unit in a centralized manner under the asset pool maintained by the computing server 130. In another case, a user may use another keyphrase such as “/ethereum send” to specify that the transfer is through the blockchain ETHEREUM in a decentralized manner. Other actions related to various blockchain-based units may also be possible, such as buy, sell, deposit, redeem, exchange, offer, accept offer, etc. In a second example, an action is a user's participation in an auction process using various blockchain-based units. A user may use the keyword “/mid” to initiate the action. In a third example, an action is a transfer of a quantity of a non-blockchain-based unit. In a fourth example, an action is related to a smart contract that is recorded on a block of a blockchain. Through a text message, a user may command the computing server 130 to broadcast information to a blockchain network. In a fifth example, any suitable action that can be performed in a blockchain is sent from the user to the computing server 130.

In a decision stage, the computing server 130 determines 340 whether the action identified in the text message is valid. For example, the computing server 130 first validates a command included in the text messages is valid, such as by determining whether the parsed information includes sufficient information to carry out the action. The parsed information may come from the text message that includes the defined action keyphrase or from related text messages (such as quoted messages, other recent messages that were sent within a threshold period, messages sent from the same sender, messages that include the same metadata tags, etc.). For example, a text string concerns a transfer of a quantity of a blockchain-based unit from a first user to a second user. In this example, the transfer is the action. A valid text message (or a valid group of text messages) that sufficiently defines a valid action may include the defined action keyphrase, an identifier of the particular blockchain-based unit, a quantity of the blockchain-based unit, and a recipient. In some cases, the recipient may be identified by a message quoting a recipient's message. A message “/transfer 0.05 eth” or “/transfer 0.05 eth to # user_B” may be examples of messages that carry valid action commands because they include a defined action keyphrase/transfer, a quantity of 0.05, and a blockchain-based unit identifier “eth,” which may represent ETHER. The computing server 130 may define valid syntax in order for a message to carry a valid action command. For example, the computing server 130 may specify that the quantity and blockchain-based unit identifier need to succeed the defined action keyphrase in order for a text message to be valid, but the two parameters' relative positions may be interchanged. In some cases, if the user specifies that a transfer action is to be carried out in a blockchain, the text message may also need to include a recipient blockchain address or the recipient may need to have an account in the computing server 130.

In determining 340 whether the action in the text message is valid, the computing server 130 also validates whether the action requested by the user is valid. The validation may include verifying that data associated with the user profile does not contradict the requested action. The validation may also check whether the user has the authority and privilege to request for the action. Using the action of transferring a quantity of blockchain-based unit from a first user to a second user as an example, there can be several stages for executing the action. The computing server 130 reads the information of the commanding user, including the user's unique identifier in the messaging platform 140 and the user action in the computing server 130. The computing servers 130 also refers to an action mapping table to review the type of action as specified in the defined action keyphrase. The computing server 130 confirms that the user has sufficient balance to initiate the transfer and also verify other prerequisites for the transfer have been met (e.g., the user has an account with the computing server 130). The computing server 130 may respond to the user if there is insufficient balance. The computing server 130 determines the recipient and begins the process of executing the action.

In response to determining that the requested action in the text message is invalid, the computing server 130 may return to step 320 to continue to monitor messages in the conversation and parse potential action keyphrases in the conversation. In response to determining that the requested action in the text message is valid, the computing server 130 executes the action.

By way of example, in executing the action, the computing server 130 stores 350, in a database, new data associated with a user, such as the user who sends the text message that includes the action keyphrase. The new data may record the action executed by the computing server 130. For example, the new data may reflect a change in a blockchain-based unit in accordance with the action corresponding to the defined action keyphrase. If the action is a transfer from a first user to a second user, the new data stored in the datastore 135 may include a transaction of the quantity of the blockchain-based unit from the first user to the second user. In some cases, two pieces of new data may be generated. First new data may record a debit of the balance of the sender user. Second new data may record a credit of the balance of the recipient user. Depending on the type of action requested, the computing server 130 may carry out additional or alternative steps to complete the action. For example, if the action requires a transfer through a blockchain 150, the computing server 130 broadcasts a transaction to a blockchain network to record the transfer. Other suitable actions are also possible.

The actions that can be requested by the users are not limited to a single messaging platform 140. For example, a user of the computing server 130 may send a text message at a first messaging platform 140A to transfer a quantity of a first blockchain-based unit to another user. The computing server 130 debits the user's account based on the first transfer. The user may send another text message at a second messaging platform 140B to transfer another quantity of the first blockchain-based unit (or a second blockchain-based unit) to a third user. The computing server 130 debits the user's account based on the second transfer. In other words, users of the computing server 130 may manage and access their balances across multiple messaging platforms 140. For example, a user may deposit a quantity of a blockchain-based unit (e.g., 1 BITCOIN) into the central ledger system 235 of computing server 130. The user can access the deposited unit via a first social media application (e.g., TELEGRAM) and can transfer a quantity of the blockchain-based unit (e.g., 0.1 BITCOIN) to another user. The user may log in to a second social media application (e.g., SLACK) and transfer another quantity of the blockchain (e.g., 0.25 BITCOIN) to a third user. The user may check his balance at TELEGRAM, SLACK, or a mobile application published by the computing server 130 and determine that he has 0.65 BITCOIN in the balance.

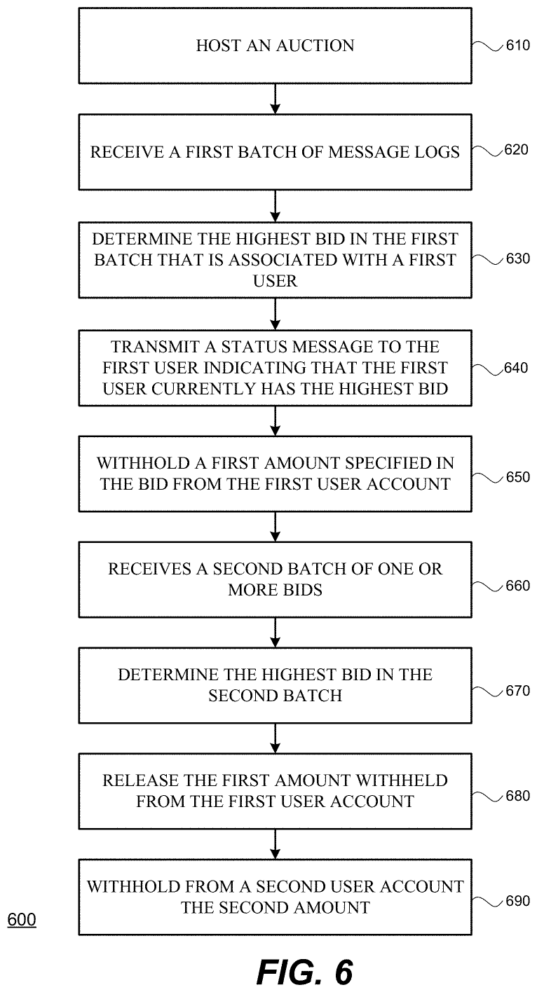

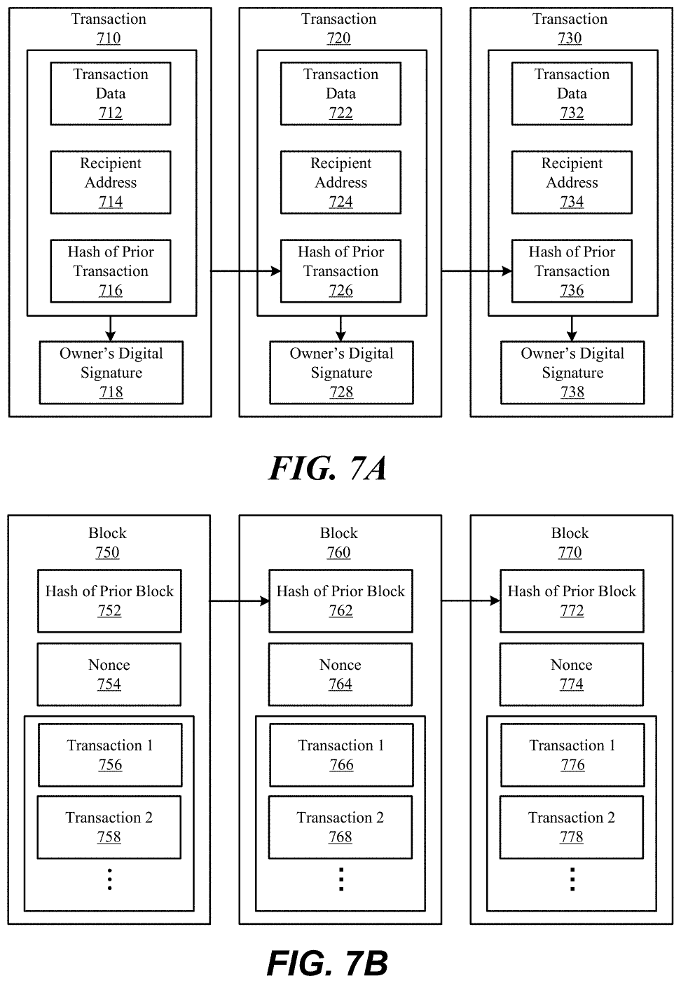

In some cases, the computing server 130 also supports cross-messaging platform activities. For example, a first user of a first messaging platform 140A can send a blockchain-based unit to a second user of a second messaging platform 140B through a text message in the first messaging platform 140A. The computing server 130 stores associations between various user accounts and user identifiers in different messaging platforms 140 so that senders and recipients in different messaging platform 140 can be identified in cross-platform activities. The sender may have a friend list that is stored in the user profile data in computing server 130. The friend list may include users from different messaging platforms 140 so that the sender can send to different recipients regardless of messaging platforms 140. In another example, the computing server 130 may set up an auction, whose process will be discussed in further detail in FIG. 7. The auction may be participated by users in different messaging platforms 140. In a third example, a user may initiate a trading session or a selling session with a product involved. Users from various messaging platforms 140 can participate in the trading session. The product can be traded with a blockchain-based unit through any one of the messaging platforms 140.

After the action is completed, the computing server 130 transmits 360, through the messaging platform 140 to the first user (e.g., the requester of the action), a confirmation of the change that is resulted from the action. The action may or may not be conducted through a blockchain 150. For example, if the action is carried out through a blockchain 150, the computing server 130 may wait until a transaction is recorded on a block that is confirmed multiple times before the confirmation is transmitted. In one embodiment, the computing server 130 uses a central ledger system 235 to complete a transfer to allows a fee-less and largely instantaneous transaction. In this context, a process is instantaneous if the process can be completed within a period that is significantly short, sometimes orders of magnitude shorter (e.g., 10 times shorter), than an averaged time a new block is generated from a blockchain. For example, the average block time for ETHEREUM is between 10 to 20 seconds. An instantaneous transfer process may be able to confirm the transfer within 2 to 3 seconds. The computing server 130 uses the central ledger system 235 to change the data related to the sender and the recipient to reflect a transfer without recording the transfer in the blockchain. Hence, the transfer may be completed without a fee and instantaneously. Put differently, the computing server 130 may execute an action off-chain so that the action is performed without a recording a transaction in the blockchain so that the blockchain-based unit remains connected, in the blockchain, to one of the cryptographic public keys of the computing server 130 during the storage 350 of the new data in the datastore 135 and during transmission 360 of the confirmation.

In one embodiment, the computing server 130 continues to handle other transfers using the central ledger system 235 until a blockchain-based unit is withdrawn by a user. In response to the user requesting a withdrawal, the computing server 130 transfer the requested quantity of the blockchain-based unit to the user's blockchain address through a blockchain recordation process. In another embodiment, the computing server 130 periodically broadcasts the settled transactions (e.g., transfers that are completed) or a version of the settled transactions (e.g., a summary, an anonymized version) to a blockchain for recordation.

The use of the messaging platform 140 and the computing server 130 allow different types of transactions to occur. In one embodiment, the transfer of a blockchain-based unit may be completed for a user of a messaging platform 140 who does not have a user account with the computing server 130 (e.g., someone who has not used the computing server 130 before). For example, in a conversation, a user of the computing server 130 may use a text message to send a quantity of a blockchain-based unit to a second person who has not used the computing server 130 before. The computing server 130 determines that the second person does not have an account with the computing server 130. For example, the computing server 130 checks if the user identifier of the second person used in the messaging platform 140 to see if there is a user account in the computing server 130 has an association with the user identifier. In response to the determination that the second person does not have an account with the computing server 130, the computing server 130 creates a new user account in the datastore 135 for the second person. To complete the transfer, the computing server stores new data associated with the second person. The new data reflects that the blockchain-based unit becomes associated with the second person in accordance with the action corresponding to the defined action keyphrase in the text message.

The computing server 130 also allows the exchange of any pair or multiple cross-pairings of blockchain-based units instantaneously. The computing server 130 allows users on an ad hoc basis to perform exchanges of one or more blockchain-based units into one or more other blockchain-based units via an over-the-counter mechanism. This process allows users to propose a sale, buy, or trade method while no order book is maintained. The central ledger system 235 in the computing server 130 settles any proposal agreed to by both parties.

In a proposed sales process, a user, assuming he has sufficient balances stored on the central ledger system 235, may write a “proposed sale” command on a messaging application 120 or a native application. The command may specify three components—the blockchain-based unit offered, the price offered, and the types of units the user is willing to accept. For example, Party A wants to sell 10 DOGE coins. He would then write in the command that may look as simple as “/Offer 10 DOGE @ 0.50 usd—accept BTC, ETH, LTC, PAR.” The three components are the amount and blockchain-based units being offered, in this case, 10 DOGE coin, the price being quoted in USD in this case (though quotes can range in the fiat or cryptocurrency price), and what individual or combination of blockchain-based units or other non-blockchain-based units he is willing to accept. Party B is in the market and would like to buy these 10 DOGE coins, and he holds sufficient balances in both LTC and PAR. He can now respond to the command offer “/accept_offer @ 0.50 usd-100 pct LTC”. This now accepts the offer, exchanging LTC for DOGE given his “100 pct” indication to settle the trade with 100 percent Litecoin balances. The central ledger system 235 uses indexes of values of coins traded against fiat currencies, and calculates the exact amount of LTC that will be required to settle this trade. After the action is completed by the computing server 130, the computing server 130 gives a final confirmation to each party—quoting exactly what each is to receive. Assuming both send the “/accept” command and agree to the trade, the computing server 130 moves 10 DOGE from the balance of Party A to the balance of Party B, and conversely moves 0.005 LTC from the balance of Party B to the balance of Party A (assuming 0.005 is the exact equivalent of 50 cents). This method claims to process also multi-currency transactions (one to one, one to many, and many to one), whereby Party A could offer x,y,z currencies for exchange, and party B could accept the offer and provide some of a,b,c currencies to settle and the computing server 130 will calculate and instantly settle the exchange.

In a proposed buy process, the computing server 130 allows a user to propose a purchase of a blockchain-based unit at a price and indicate what he is willing to deliver in exchange. Suppose Party D wishes to purchase 100 BAT and 200 WYS, and currently has in his balance PAR, DOGE and BITCOIN. Party D would initiate the command as “Mid 100 BAT & 100 WYS @ 0.05 btc—offer PAR, DOGE, BTC.” This command has several components. The components include the blockchain-based units being bid on, in this case two currencies BAT, and WYS, and the amounts bid, as well as the price (quoted in BITCOIN this time), and what the user is willing to pay to a selling party, PAR, DOGE or BTC. Supposed party G is in the market for BTC and PAR, and has sufficient WYS and BAT balances to sell, he can take the other side of the trade and agree to sell by responding to the command “/accept_bid @ 0.05 btc-50 pct BTC 50 pct PAR”. The computing server 130 will now calculate the ending result trade, deliver a final confirmation to each participant and once accept settle the trade. In this case Party D will be delivering 50 percent of the value of Bitcoin (0.025 btc) and 50 percent in PAR (suppose 1000 PAR) to Party G, and Party G will be delivering 100 BAT and 200 WYS. The computing server 130 receives a confirmation of this trade from both parties, and then settles the trade by reducing the balance of Party D by 0.025 BTC and 1000 PAR, adding 0.025 BTC and 1000 PAR to the balance of Party G, and simultaneously reducing the balance of Party G by 100 BAT and 200 WYS, and adding the 100 BAT and 200 WYS to the balance of Party D. This method allows for trades of one to one, one to many, many to one, or many to many blockchain-based units.

In a trade process, the computing server 130 allows trades of one to one, one to many, many to one, or many to many blockchain-based units in the exchange. This method allows a party to propose a direct trade of one or several quantities of blockchain-based units in exchange for an exact amount of other blockchain-based units. Suppose Party Z holds balances in BTC and ETH. Party Z would like to exchange this for LTC and DOGE. Party Z can propose a trade command saying “/trade 0.005 BTC & 0.01 ETH against 2 LTC & 50 DOGE.” This trade specifies an exact amount to be settled from a counterparty. Assume Party Y sees this proposed trade and accepts the trade with an “/accept_trade” command, the computing server 130 will instantaneously reduce the balance of Party Z by 0.005 BTC and 0.01 ETH, add 0.005 BTC and 0.01 ETH to Party X's balance, and reduce the balance of Party X by 2 LTC and 50 DOGE and increase the balance of Party Z by 2 LTC and 50 DOGE coin.

### Example Graphical User Interface

FIG. 4A is a conceptual diagram illustrating an example graphical user interface (GUI) 400 of a messaging application 120 used in a user device 110, in accordance with an embodiment. The messaging application 120 is connected to a messaging platform 140. In the example shown in FIG. 4A, the GUI 400 currently shows a conversation named “GroupChat 2020” with 14 members. A user may type text messages in the type field 405 and can generate other types of messages such as a voice message using the microphone button 410. For example, the user device 110 is controlled by UserA and UserA typed “Hi” to generate a first message 415. The conversation is monitored by a computing server 130. UserB quotes the first message 415 and transmits a text message 420 that includes a defined action phrase “/tip.” By quoting message 415, the computing server 130 determines that the recipient is intended to be UserA. UserB also specifies a quantity (200) of a particular blockchain-based unit “doge.” The computing server 130 parses the text message 420 and determines that the command in the text message 420 is valid (e.g., checking the balance of UserB). In turn, the computing server transmits a confirmation 425 to the UserB by sending the confirmation to the conversation. The confirmation 425 is sent instantaneously after message 420 is sent (both sent at 1:54 pm), which is faster than a block generation speed of a blockchain.

The messaging application 120 also allows users to launch a sub-application operated by the computing server 130 through a text message command. UserC sends a message 430, which includes another defined action keyphrase “@parjar_bot,” which is an example keyphrase that causes the messaging application 120 to goes to an embedded application of the computing server 130, which will be discussed in further detail with reference to FIG. 4B.

The users may also use other defined action keyphrases to perform a similar transfer action. For example, quoting UserA's message 415, UserD uses the message 435 that includes another action keyphrase “/chute” to transfer 1000 PAR to UserA. The message 435 may include other irrelevant information without affecting the action executed by the computing server 130. For example, the message 435 includes “welcome mate,” which is not relevant to the transfer. The computing server, in executing the action, instantaneously sends a confirmation 440 to the conversation.

FIG. 4B is a conceptual diagram illustrating an example sub-application 450 of messaging application 120, in accordance with an embodiment. In the example shown in FIG. 4B, the sub-application is named ParJar bot, which is launched by a user sending the keyphrase “@parjar_bot” in the messaging application 120. The sub-application 450 may be operated by the computing server 130 through an API of the messaging platform 140. The user may exit the sub-application by going back to the conversation menu through a control element 465.

When a user issues a command keyphrase to launch the sub-application 450, the computing server 130 creates, through the sub-application 450, a chatroom between the user and the computing server 130. The chatroom may operate similarly to the messaging application 120 and include the type field 455 and one or more control elements 460 (e.g. a deposit button, a check balances button, etc.). The computing server 130 may receive an inquiring text message 470 from the user inquiring information of the user's account in the computing server 130. The data of the user account may be stored in the datastore 135. The inquiring text message 470 may be generated by the user typing “check balances” in the type field 455 or pressing the control element “Check Balances.” In response, the computing server 130 transmits a response 475, which may be in the form of text message, to the user through the chatroom. The response text message 475 includes the information inquired by the user, such as balances of different blockchain-based units in the user account. The user may issue more complex commands such as deposit 480. The computing server 130 may respond by providing instruction prompts in the form of a text message (e.g., message 485) and may generate additional control elements 490 to complete the command.

### Example Deposit and Withdrawal Processes

FIG. 5A is a flowchart depicting a first example process 500 for depositing a blockchain-based unit to a computing server 130, in accordance with an embodiment. In the deposit process 500, the computing server 130 receives, from a user device, a request 502 for a deposit of a blockchain-based unit to the computing server 130.

The computing server 130 may respond to the deposit request 502 in different ways based on the types of blockchain network. For a first type of blockchain networks, such as BITCOIN, the computing server 130 generates 503a a new pair of cryptographic keys. For example, the computing server 130 generates a new cryptographic private key for the user and save an association between the newly generated private key with the user. In other words, for certain blockchain network, a unique private key is specifically associated with each user. In some cases, the newly generated private key is generated from a master private key held by the computing server 130. The newly generated private key, in turn, generates a cryptographic public key, which derives a blockchain address for the user. The new blockchain address unique to the user. The computing server 130 requests blockchain address 504a from a node of a blockchain network. The node of the blockchain network, which can be part of the computing server 130 such as part of the blockchain interfacing engine 215, generates 506a a blockchain address of the computing server 130 based on a cryptographic public key of the computing server 130. The computing server 130 creates an association between a user account of the user and the blockchain address. The association may be saved in the user profile.

For a second type of blockchain networks, such as ETHEREUM, the computing server 130 may ask 503b for the sender address. In response, the user device 110 provides 504b the sender blockchain address. The computing server 130 saves the sender address in the user account so that the computing server 130 can identify that repeated deposits from the same sender address are from the same user. In the deposit process for this type of a blockchain network, the computing server 130 may not generate a new deposit blockchain address for the use. The deposit blockchain address may be associated with the master public key owned by the computing server 130, which pools the deposits for that blockchain network for the users in the central ledger system.

In either types of blockchain networks, The computing server 130 transmits a deposit instruction 508 to the user device 110. The deposit instruction 508 includes the blockchain address for the deposit. The blockchain address may be a newly generated address for the first type of blockchain networks or a master blockchain address for the second type of blockchain networks.

The user devices 110 broadcasts a transfer 510 in the blockchain network. The transfer 510 is a transaction that is sent to the nodes in the blockchain network to wait for recordation of the transaction in one of the blocks. Through the block generation process such as mining or voting, the blockchain 150 generates 512 new blocks. The transfer 510 may be recorded in one of the blocks. The computing server 130 may periodically send inquiries 514 to the blockchain 150 to confirm the recordation of a blockchain transaction that involves the blockchain address. The blockchain transaction confirms the deposit has taken place. The computing server 130 may wait until a few blocks succeed the block that includes the transaction to confirm that the deposit is complete and valid. The computing server 130 changes 518 the balance of the blockchain-based unit in the user account associated with the user. The computing server sends a deposition confirmation 518 to the user device 110 indicating that the deposit has completed. The confirmation 518 may include the balances of the user account and may be sent through a messaging platform 140. The user device 110 retains 520 the blockchain address of the computing server 130 for future deposits for the first type of blockchain networks and retains 520 the blockchain address of the sender for the second type of blockchain networks. The computing server 130 also retains 522, subsequent to changing 516 the balance of the user account, the blockchain address and the association between the user account and the blockchain address of the computing server 130 for future deposits.

By saving the blockchain address, the user device 110 may carry out additional deposits 524 by directly broadcasting more transfer 510 from a user blockchain address to the computing server blockchain address without requesting for another blockchain address from the computing server 130. For each of the deposits, the sender's address might be different. The computing server 130 automatically credit the user account if a blockchain-based unit is transmitted to the computing server blockchain address that is uniquely reserved for the user. Another user has a different computing server blockchain address. Conventionally, depositing cryptocurrency to an exchange, a wallet, or other entity has been cumbersome and presents security flaws. Current technology requires that users request a new deposit transaction each and every time. This means that users cannot store a deposit address or become a known beneficiary. Users also need to accept the risks of copying or typing a new address with each transaction. The process 500 creates a secure, trusted, and fast mechanism for users to continually deposit blockchain-based units to the computing server 130. Since the deposits are sent to the same computing server blockchain address, the total amount of deposits can be verified by a third party.

FIG. 5B is a flowchart depicting a second example process 550 for depositing a blockchain-based unit to a computing server 130, in accordance with an embodiment. The deposit process 550 may be used with certain types of blockchains 150 that support smart contracts, such as ETHEREUM. Some of those blockchains do not allow a private key to generate multiple blockchain addresses. To facilitate the deposit process, the computing server deploys a primary smart contract 530 and one or more subsidiary smart contracts 540. The smart contracts 530 and 540 are recorded on the blockchain 150. The primary smart contract 530 is a set of instructions that will generate and control the subsidiary smart contracts 540. Each subsidiary smart contract 540 is programmed to automatically forward blockchain-based units to the blockchain address of the computing server 130. The primary smart contract 530 initiates a cross-contract sweep on a regular basis as needed to pull the balances from each subsidiary smart contract 540 to the central ledger system 235 of the computing server 130. The frequency of such cross-contract sweep may be determined by the buildup of blockchain-based units in each subsidiary smart contract 540 and the total amount in the central ledger system 235. As such, excessive blockchain-based units are not sitting idly in a subsidiary smart contract 540. The central ledger system 235 of the computing server 130 also has sufficient liquidity to support withdrawals and other blockchain transactions.

A user device 110 initiates a deposit request 552 for a blockchain-based unit, for example via a native application or a messaging application 120. The computing server 130 receives the deposit request 552 and forward 554 a version of the request to the primary smart contract 530. A version of the request can be the request itself or an adjusted version, such as a request that is formatted to be compatible with the primary smart contract 540. In response, the primary smart contract 530 deploys 556 a new subsidiary smart contract 558 for the user. The computing server 130 assigns 560 the newly generated subsidiary smart contract 540 to the user. For example, the computing server 130 stores an association between the newly generated subsidiary smart contract 558 and the user in the user account. The computing server 130 responds to the user device 110 by sending a deposit instruction 562 that includes a blockchain address of the newly generated subsidiary smart contract 558. The deposit instruction 562 can be sent from a mobile application or a messaging platform 140. The deposit instruction 562 indicates that the user should deposit the blockchain-based unit to the subsidiary smart contract 558.

The user device 110 broadcasts a transfer 564 of the blockchain-based unit form the user address to the blockchain address of the subsidiary smart contract 558. After the transfer 564 is recorded in a new block, the subsidiary smart contract 558 determines 566 the types of the blockchain-based unit that is transferred. If the blockchain-based unit is native to the blockchain (e.g., ETHER in ETHEREUM), the subsidiary smart contract 558 automatically records the receipt of the unit and transfers 568 the unit to the blockchain address of the computing server 130. If the blockchain-based unit is a token generated by the primary smart contract 530 or other smart contracts recorded in the blockchain, such as tokens that are generated under ERC20 or other blockchain standards, the subsidiary smart contract 540 queries the balance and the primary smart contract 530 periodically sweeps the tokens.

The computing server 130 periodically sends inquiries 570 to the blockchain 150 to examine new blocks. If the deposit is recorded on a confirmed block, the computing server 130 transmits a deposit confirmation 572 to the user device 110. After the completion of the deposit, the user device 110 retains 576 the blockchain address of the subsidiary smart contract 558 that is generated for the user. The computing server 130 also retains 578 an association between the blockchain address of the subsidiary smart contract and the user account. The computing server 130 determines the user balances of various users by tracking which subsidiary smart contracts 540 transmit the blockchain-based units to the blockchain address of the computing server 130. The user may repeat 580 additional deposits by directly broadcasting additionally transfers to the blockchain address of the subsidiary smart contract 558 without asking for another deposit instruction.

Withdrawal processes for a blockchain-based unit to be withdrawn from the computing server 130 to a user are similar to the processes 500 and 550, except that some of the steps may be reversed in order to send the unit from the blockchain address of the computing server 130 to the user blockchain address.

By way of example, a withdrawal can be processed to remove a blockchain-based unit from the computing server 130. In a withdrawal process, a user interacts with the computing server 130 on the native application or a messaging platform 140. He may issue a command to “withdraw” the blockchain-based unit. The command includes the amount and the user blockchain address to which the blockchain-based unit is delivered. The computing server 130 pings the associated blockchain network for a transaction time estimate and fee estimate. The computing server 130 reports to the user approximate time for the transaction to be completed and the cost of the network fees. The user confirms with the computing server 130 to begin the withdrawal process. The computing server 130 deducts the balance from the ledger of the user, generates a signed blockchain-based unit transaction using the private key of the computing server 130, and broadcasts the signed transaction to the blockchain network for recordation. The transaction signature uses the main address and private key information of the computing server 130, not of the user. The transaction is confirmed and loaded onto the blockchain, which subtracts the balance from the computing server blockchain address, and adds the balance to the user's balance at the user blockchain address. The blockchain-based units withdrawn by the user may come from the central ledger system 235 and may or may not include the units that reside at the blockchain deposit address unique to the user. For example, when a user deposits blockchain-based units to the computing server 130 using the process 500 shown in FIG. 5A, the units are deposited to the same blockchain address that corresponds to a private key of the computing server 130 that is generated for the user. The deposited units are considered to be in the pool of the central ledger system 235. The withdrawn units do not need to come from those units that reside at the deposit address generated for the user.

### Example Auction Process

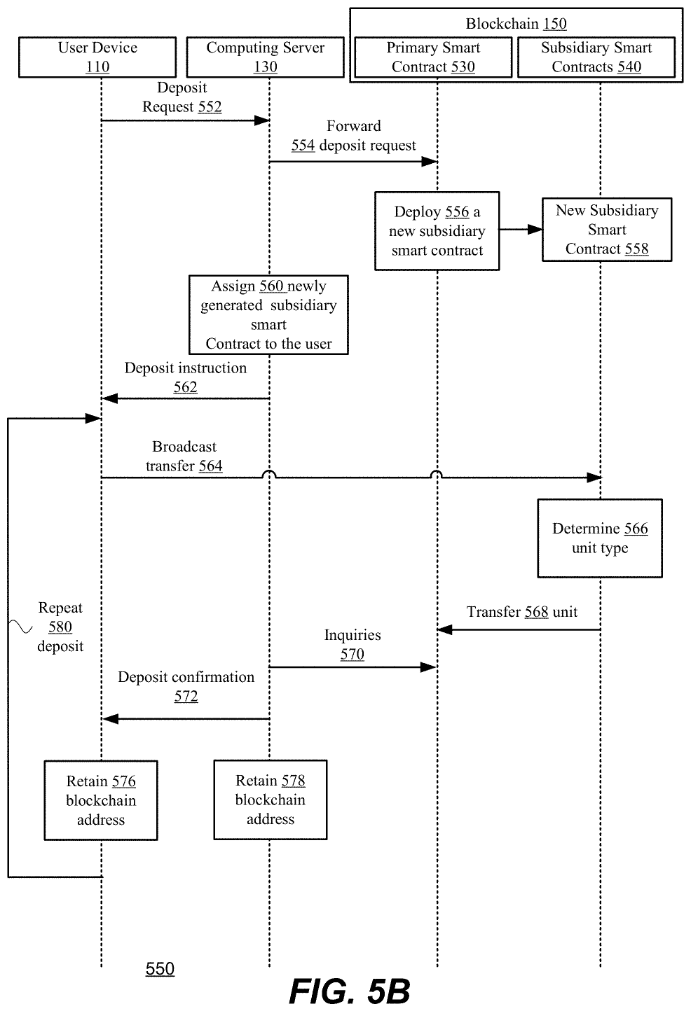

FIG. 6 is a flowchart depicting an example process 600 of conducting an auction using blockchain-based units under the central ledger system 235 of the computing server 130, in accordance with an embodiment. Conventionally, blockchain-based units have long settlement time so that an auction process is challenging to carry out using blockchain-based units.

In one embodiment, the computing server 130 hosts 610 an auction for an asset. The auction can be hosted on a messaging platform 140 or across multiple messaging platforms. The auction can be held using a single blockchain-based unit, multiple blockchain-based units, or a mix of blockchain and non-blockchain-based units. The computing server 130 receives 620, from one or more messaging platforms 140, a first batch of one or more bids. The bids can be carried in one or more message logs. The one or more message logs includes one or more action keyphrases specifying one or more bid actions associated with the auction. In some cases, the bid actions may include bids that use different blockchain-based units. The computing server 130 may use an exchange rate to determine the bid amounts in each bid. The computing server 130 determines 630, among the plurality of bids, the highest bid that is associated with a first user in the first batch. The computing server 130 transmits 640 a status message, such as through a messaging platform 140, to the first user with the highest bid indicating the first user currently has the highest bid. The computing server 130 withholds 650, from a first user account of the first user of the computing server 130, a first amount specified in the highest bid.

The computing server 130 receives 660 a second batch of one or more bids. The second batch includes additional bid actions. The computing server 130 determines 670 the highest bid in the second batch. The highest bid in the second batch higher than the highest bid in the first batch and is initiated from a second user. The computing server 130 releases 680 the first amount withheld from the first account. The computing server 130 withholds 690 from a second account of the second user a second amount specified in the highest bid in the second batch. The computing server 130 also notifies the second user that he has the highest bid. The computing server 130 may repeat the process until the auction is ended and the final highest bid is determined. When the auction is completed, the computing server 130 settled the transaction using the withheld amount. The computing server 130 allows a process to instantly, feelessly and trustlessly settle blockchain-based units for auctions and for direct purchases of assets.

By way of a specific example of an auction process, the Computing server 130 can have a unique command “/bid”, which can be in the full format of “Mid [amount] [currency] for [asset name].” The computing server 130 can record the highest bid in multiple blockchain-based units using an API that retrieves USD equivalent prices of each blockchain-based unit. The bid method may ask bidders to increase their bid in increments large enough such that the price new highest bid is significantly different enough from the former bid to prevent auction currency fluctuations. The auction may set the prices of each currency allowable in the auction at the start time of auction so that no market volatility will affect the auction, but the method may allow for prices to be updated throughout auction during times of high volatility that may significantly alter the highest bids.

The auction process may have four stages. In the first stage, the computing server 130 receives a command from an application. The command “Mid” starts the bidding process, indicating to the computing server 130 to execute the command. In the second stage, the computing server 130 digests the command and the commanding party information. It identifies the commanding party and confirms that the party is a user of the computing server 130 (e.g., has a balance and identifiable in the database), that the party's ledger balance is sufficient for the bid placed, and that the bid is incrementally higher than other previous bids. This confirmation process prevents false bids where potential participants could distort the auction by placing bids they cannot afford. Balances of all participants are updated in real-time so that deposits, withdrawals, and other transactions would be factored in to ensure the balance is sufficient. If the party does not exist in the database, does not have enough balances, or has bid below the highest bid, the computing server 130 will transmit in the application a response to the user and to the group that the bid is invalid with a reason (e.g., “insufficient balances”, “this is not the highest bid for this item”).

In the third stage, the computing server 130 records the bid as the highest bid and announces this information on the application by sending an HTTP message to the server of the application to distribute the message to the channel and participants. The computing server 130 locks up the bid amount within the balance of the highest bidder's ledger on the computing server 130. In this manner, the highest bidder cannot withdraw or spend the amount of blockchain-based units that have been bid. Assuming the participant's crypto balance is higher than his current bid, he may transfer, tip, spend, withdraw that amount in excess of the bid. For example, suppose Party A submits a bid of 1.3 bitcoin for a piece of Art (“/bid 1.3 BTC for Art”), and suppose that Party A's ledger balance within the computing server 130 is 1.6 bitcoin. Party A may send or withdraw up to 0.3 bitcoin without issue. However, should Party A attempt to withdraw 0.4 bitcoin, the computing server 130 would not execute this command and respond with an error to Party A. If, however, party A deposited an additional 0.1 bitcoin, or received 0.1 bitcoin from another member, Party A could then re-command the withdrawal of 0.4 bitcoin from the central ledger without issue.

The process of recording new bids and the highest bidder continues until the time of auction has expired or an administrator has deemed the auction to be complete. At this point, the computing server 130 executes the fourth and final stage, transferring the balance from the highest bidder to the seller at auction. Because the computing server 130 has confirmed that there is sufficient balance of the ledger of the highest bidder, it immediately reduces the highest bidder's balance by the amount of the bid and adds that amount to the balance of the selling party.

The computing server 130 may have a method whereby the highest bidder is given the option to wait until confirming that the assets have been delivered by a seller before releasing the blockchain-based units to the seller. This would be an additional option included in the auction terms, which are presented to both parties for confirmation. The process can apply in both physical real-world auctions as well as auctions held only online but with physical and/or digital delivery of assets.

The computing server 130 can also perform a settlement of blockchain-based units for the purchase of assets on third party webpages. The buyer and the seller are users of the computing server 130. The computing server 130 receives a command from the purchasing party, identifies the selling party and executes the command. If the command is for a purchase, the end result will be the instantaneous transfer of blockchain-based units from the balance of the commanding party to the selling party. This process can be built into the website of the 3rd party alongside other typical payment options. Both the purchaser and seller are users of the computing server 130.

By way of example, the computing server 130 executes a transfer of blockchain-based units from the balance of the purchaser to the balance of the seller, reducing the ledger balance of the purchaser and increasing the balance of the seller on the associated within the computing server 130. The computing server 130 may leverage a “plugin” or “extension” or similar technology built directly into the web explorer application. This plugin allows the purchaser to log into the computing server 130 and view balances, and also to confirm transactions sent over the web pages. When the purchaser is in the final stages of purchasing an item off of the retail web page, the purchaser can be in a GUI that allows the purchaser to click on the payment box and choose the computing server 130 as the method of purchase, which can be a branded version of the computing server 130. The selection of the computing server 130 would prompt the purchaser and allow them to pay with blockchain-based units. The purchaser can confirm the amount of blockchain-based units based on the merchant preferences, and would respond to the plugin box with a “confirmed” command. This causes the computing server 130 to execute the transfer of the blockchain-based units from the purchaser to the seller within the computing server 130. The computing server 130 notifies the merchant of the purchase so that the seller can begin to deliver of the assets purchased. The computing server 130 may allow for merchants to show a USD or GBP or other currency amount and would convert the acceptable blockchain-based units amount based on currency market prices of crypto vs those currencies.

### Example Blockchain Architecture

FIG. 7A is a block diagram illustrating a chain of transactions broadcasted and recorded on a blockchain, in accordance with an embodiment. The transactions described in FIG. 7A may correspond to any of the transactions and the transfer of blockchain-based units described in previous figures.

In some embodiment, a blockchain is a distributed system. A distributed blockchain network may include a plurality of nodes. Each node is a user or a server that participates in the blockchain network. In a public blockchain, any participant may become a node of the blockchain. The nodes collectively may be used as a distributed computing system that serves as a virtual machine of the blockchain. In some embodiments, the virtual machine or a distributed computing system may be simply referred to as a computer. Any users of a public blockchain may broadcast transactions for the nodes of the blockchain to record. Each user's digital wallet is associated with a cryptographic private key that is used to sign transactions and prove the ownership of a blockchain-based unit. For example,

The ownership of a blockchain-based unit may be traced through a chain of transactions. In FIG. 7A, a chain of transactions may include a first transaction 710, a second transaction 720, and a third transaction 730, etc. Each of the transactions in the chain may have a fairly similar structure except the very first transaction in the chain. The first transaction of the chain may be generated by a smart contract or a mining process and may be traced back to the smart contract that is recorded on the blockchain or the first block in which it was generated. While each transaction is linked to a prior transaction in FIG. 7A, the transaction does not need to be recorded on consecutive blocks on the blockchain. For example, the block recording the transaction 710 and the block recording the transaction 720 may be separated by hundreds or even thousands of blocks. The traceback of the prior block is tracked by the hash of the prior block that is recorded by the current block.

Referring to one of the transactions in FIG. 7A, for illustration, the transaction 720 may be referred to as a current transaction. Transaction 710 may be referred to as a prior transaction and transaction 730 may be referred to as a subsequent transaction. Each transaction includes a transaction data 722, a recipient address 724, a hash of the prior transaction 726, and the current transaction's owner's digital signature 728. The transaction data 722 records the substance of the current transaction 720. For example, the transaction data 722 may specify a transfer of a quantity of a blockchain-based unit (e.g., a coin, a blockchain token, etc.). In some embodiments, the transaction data 722 may include code instructions of a smart contract.

The recipient address 724 is a version of the public key that corresponds to the private key of the digital wallet of the recipient. In one embodiment, the recipient address 724 is the public key itself. In another embodiment, the recipient address 724 an encoded version of the public key through one or more functions such as some deterministic functions. For example, the generation of the recipient address 724 from the public key may include hashing the public key, adding a checksum, adding one or more prefixes or suffixes, and encoding the resultant bits. The recipient address 724 may be a unique identifier of the digital wallet of the recipient on the blockchain.

The hash of the prior transaction 726 is the hash of the entire transaction data of the prior transaction 710. Likewise, the hash of the prior transaction 736 is the hash of the entire transaction data of the transaction 720. The hashing of the prior transaction 710 may be performed using a hashing algorithm such as a secure hash algorithm (SHA) or a message digest algorithm (MD). In some embodiments, the owner corresponding to the current transaction 720 may also use the public key of the owner to generate the hash. The hash of prior transaction 726 provides a traceback of the prior transaction 710 and also maintains the data integrity of the prior transaction 710.

In generating a current transaction 720, the digital wallet of the current owner of the blockchain-based unit uses its private key to encrypt the combination of the transaction data 722, the recipient address 724, and the hash of prior transaction 726 to generate the owner's digital signature 728. To generate the current transaction 720, the current owner specifies a recipient by including the recipient address 724 in the digital signature 728 of the current transaction 720. The subsequent owner of the blockchain-based unit is fixed by the recipient address 724. In other words, the subsequent owner that generates the digital signature 738 in the subsequent transaction 730 is fixed by the recipients address 724 specified by the current transaction 720. To verify the validity of the current transaction 720, any nodes in the blockchain network may trace back to the prior transaction 710 (by tracing the hash of prior transaction 726) and locate the recipient address 714. The recipient address 714 corresponds to the public key of the digital signature 728. Hence, the nodes in the blockchain network may use the public key to verify the digital signature 728. Hence, a current owner who has the blockchain-based unit tied to the owner's blockchain address can prove the ownership of the blockchain-based unit. In this disclosure, it can be described as the blockchain-based unit being connected to a cryptographic public key of a party because the blockchain address is derived from the public key. For example, the computing server 130 may own blockchain-based units in a central ledger system 235. The blockchain-based units are connected to one of the cryptographic public keys of the computing server 130.

The transfer of ownership of a blockchain-based unit may be initiated by the current owner of the blockchain-based unit. To transfer the ownership, the owner may broadcast the transaction that includes the digital signature of the owner and a hash of the prior transaction. A valid transaction with a verifiable digital signature and a correct hash of the prior transaction will be recorded in a new block of the blockchain through the block generation process.

FIG. 7B is a block diagram illustrating a connection of multiple blocks in a blockchain, in accordance with an embodiment. Each block of a blockchain, except the very first block which may be referred to as the genesis block, may have a similar structure. The blocks 750, 760, and 760 may each include a hash of the prior blockchain 752, a nonce 754, and a plurality of transactions (e.g., a first transaction 756, a second transaction 758, etc.). Each transaction may have the structure shown in FIG. 7A.

In a block generation process, a new block may be generated through mining or voting. For a mining process of a blockchain, any nodes in the blockchain system may participate in the mining process. The generation of the hash of the prior block may be conducted through a trial and error process. The entire data of the prior block (or a version of the prior block such as a simplified version) may be hashed using the nonce as a part of the input. The blockchain may use a certain format in the hash of the prior block in order for the new block to be recognized by the nodes as valid. For example, in one embodiment, the hash of the prior block needs to start with a certain number of zeroes in the hash. Other criteria of the hash of the prior block may also be used, depending on the implementation of the blockchain.

In a voting process, the nodes in a blockchain system may vote to determine the content of a new block. Depending on the embodiment, a selected subset of nodes or all nodes in the blockchain system may participate in the votes. When there are multiple candidates new blocks that include different transactions are available, the nodes will vote for one of the blocks to be linked to the existing block. The voting may be based on the voting power of the nodes. In one embodiment, the nodes may have equal voting power in each round. In another embodiment, one or more voting tokens may be distributed to one or more nodes. The holders of the voting tokens in a particular round may have more voting power for the round. After one or more rounds, the voting tokens may be passed to other nodes. For example, the passing of the voting tokens may be determined randomly. The use of a voting process to generate a block, which is also a decentralized process, may allow a large number of transactions to be recorded in a short period of time and avoid the delay in the mining process

By way of example of a block generation process using mining, in generating the hash of prior block 762, a node may randomly combine a version of the prior block 750 with a random nonce to generate a hash. The generated hash is somewhat a random number due to the random nonce. The node compares the generated hash with the criteria of the blockchain system to check if the criteria are met (e.g., whether the generated hash starts with a certain number of zeroes in the hash). If the generated hash fails to meet the criteria, the node tries another random nonce to generate another hash. The process is repeated for different nodes in the blockchain network until one of the nodes find a hash that satisfies the criteria. The nonce that is used to generate the satisfactory hash is the nonce 764. The node that first generates the hash 762 may also select what transactions that are broadcasted to the blockchain network are to be included in the block 760. The node may check the validity of the transaction (e.g., whether the transaction can be traced back to a prior recorded transaction and whether the digital signature of the generator of the transaction is valid). The selection may also depend on the number of broadcasted transactions that are pending to be recorded and also the fees that may be specified in the transactions. For example, in some embodiments, each transaction may be associated with a fee (e.g., gas) for having the transaction recorded. After the transactions are selected and the data of the block 760 is fixed, the nodes in the blockchain network repeat the trial and error process to generate the hash of prior block 772 by trying different nonce. In embodiments that use voting to generate new blocks, a nonce may not be needed. A new block may be linked to the prior block by including the hash of the prior block.

New blocks may be continued to be generated through the block generation process. A transaction of a blockchain-based unit (e.g., an electronic coin, a blockchain token, etc.) is complete when the broadcasted transaction is recorded in a block. In some embodiment, the transaction is considered settled when the transaction is multi-verified. A transaction is multi-verified when there are multiple subsequent blocks generated and linked to the block that records the transaction.

In some embodiments, some of the transactions 756, 758, 766, 768, 776, 778, etc. may include one or more smart contracts. The code instructions of the smart contracts are recorded in the block and are often immutable. When conditions are met, the code instructions of the smart contract are triggered. The code instructions may cause a computer (e.g., a virtual machine of the blockchain) to carry out some actions such as generating a blockchain-based unit and broadcasting a transaction documenting the generation to the blockchain network for recordation.

### Computing Machine Architecture

FIG. 8 is a block diagram illustrating components of an example computing machine that is capable of reading instructions from a computer-readable medium and execute them in a processor (or controller). A computer described herein may include a single computing machine shown in FIG. 8, a virtual machine, a distributed computing system that includes multiples nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIGS. 1 and 2, including but not limited to, the user device 110, the computing server 130, a node of a blockchain network, and various engines, modules interfaces, terminals, and machines shown in FIG. 2. While FIG. 8 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processors (generally, processor 802) (e.g., a central processing unit (CPU), a graphics processing unit (GPU), a digital signal processor (DSP), one or more application-specific integrated circuits (ASICs), one or more radio-frequency integrated circuits (RFICs), or any combination of these), a main memory 804, and a static memory 806, which are configured to communicate with each other via a bus 808. The computer system 800 may further include graphics display unit 810 (e.g., a plasma display panel (PDP), a liquid crystal display (LCD), a projector, or a cathode ray tube (CRT)). The computer system 800 may also include alphanumeric input device 812 (e.g., a keyboard), a cursor control device 814 (e.g., a mouse, a trackball, a joystick, a motion sensor, or other pointing instrument), a storage unit 816, a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor's cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the machine and that cause the machine to perform any one or more of the methodologies disclosed herein. The computer-readable medium may include, but not be limited to, data repositories in the form of solid-state memories, optical media, and magnetic media. The computer-readable medium does not include a transitory medium such as a signal or a carrier wave.

### Additional Configuration Considerations

Certain embodiments are described herein as including logic or a number of components, engines, modules, or mechanisms, for example, as illustrated in FIG. 2. Engines may constitute either software modules (e.g., code embodied on a computer-readable medium) or hardware modules. A hardware engine is a tangible unit capable of performing certain operations and may be configured or arranged in a certain manner. In example embodiments, one or more computer systems (e.g., a standalone, client or server computer system) or one or more hardware engines of a computer system (e.g., a processor or a group of processors) may be configured by software (e.g., an application or application portion) as a hardware engine that operates to perform certain operations as described herein.

In various embodiments, a hardware engine may be implemented mechanically or electronically. For example, a hardware engine may comprise dedicated circuitry or logic that is permanently configured (e.g., as a special-purpose processor, such as a field programmable gate array (FPGA) or an application-specific integrated circuit (ASIC)) to perform certain operations. A hardware engine may also comprise programmable logic or circuitry (e.g., as encompassed within a general-purpose processor or another programmable processor) that is temporarily configured by software to perform certain operations. It will be appreciated that the decision to implement a hardware engine mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 802, that are temporarily configured (e.g., by software) or permanently configured to perform the relevant operations. Whether temporarily or permanently configured, such processors may constitute processor-implemented engines that operate to perform one or more operations or functions. The engines referred to herein may, in some example embodiments, comprise processor-implemented engines.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Upon reading this disclosure, those of skill in the art will appreciate still additional alternative structural and functional designs for a similar system or process through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those skilled in the art, may be made in the arrangement, operation and details of the method and apparatus disclosed herein without departing from the spirit and scope defined in the appended claims.

1. A computer-implemented method, comprising:
maintaining, by a computing server, a plurality of blockchain-based units, the blockchain-based units, in one or more blockchains, connected to one or more cryptographic public keys of the computing server;
receiving, by the computing server from a messaging platform, data packets comprising one or more text messages of a conversation;
parsing the text messages to identify (i) a text string that matches a defined action keyphrase and (ii) a particular blockchain-based unit, the text string parsed from one of the text messages that is related to a first user;
storing new data associated with the first user, the new data reflecting a change in the particular blockchain-based unit in accordance with an action corresponding to the defined action keyphrase; and
transmitting, through the messaging platform to the first user, a confirmation of the change, wherein the particular blockchain-based unit remains connected, in one of the blockchains, to one or more of the cryptographic public keys of the computing server during storing of the new data and transmission of the confirmation, and wherein the computing server stores a plurality of user accounts, each user account including balances of one of more blockchain-based units with respect to a particular user, the blockchain-based units in each of the user accounts are connected, in the one or more blockchains, to the one or more cryptographic public keys of the computing server.

2. The computer-implemented method of claim 1, wherein the action is intended to be received by a second person, the computer-implemented method further comprises:
determining that the second person does not have an account with the computing server;
creating, responsive to the determination, a new user account for the second person;
storing second new data associated with the second person, the second new data reflecting that the particular blockchain-based unit becomes associated with the second person in accordance with the action corresponding to the defined action keyphrase.

3. (canceled)

4. The computer-implemented method of claim 1, further comprising:
receiving, from a third user, a request for a deposit of one of the blockchain-based units to the computing server;
generating a blockchain address based on one of the cryptographic public keys of the computing server, the blockchain address unique to the third user;
creating an association between an account of the third user and the blockchain address;
confirming a recordation of a blockchain transaction that involves the blockchain address, the blockchain transaction confirming the deposit;
changing the balance of the one of the blockchain-based units in the user account associated with the third user; and
retaining, subsequent to changing the balance, association between the user account of the third user and the blockchain address.

5. The computer-implemented method of claim 1, further comprising:
receiving, from a third user, a request for a deposit of one of the blockchain-based units to the computing server;
transmitting, responsive to the request for deposit, a version of the request to a primary smart contract stored in one of the blockchain, the primary smart contract, responsive to the transmitting, generate a subsidiary smart contract;
providing, to the third user, a blockchain address of the subsidiary smart contract to the user;
creating an association between an account of the third user and the blockchain address of the subsidiary smart contract;
confirming a recordation of a blockchain transaction that involves a transfer from the user address to the blockchain address of the subsidiary smart contract; and
changing the balance of the one of the blockchain-based units in the user account associated with the third user.

6. The computer-implemented method of claim 1, wherein the one of the text messages including the text string concerns a transfer of a quantity of the blockchain-based unit from the first user to a second user, the transfer is the action, and the new data includes a transaction of the quantity of the blockchain-based unit from the first user to the second user.

7. The computer-implemented method of claim 1, wherein the messaging platform comprises a sub-application operated by the computing server, and the computer-implemented method further comprises:
creating, through the sub-application, a chatroom between the first user and the computing server;
receiving an inquiring text message from the first user inquiring information of the first user's account in the computing server; and
transmitting a response text message to the first user through the chatroom, the response text message including the information inquired by the first user.

8. The computer-implemented method of claim 1, wherein the one of the text messages comprises the defined action keyphrase, an identifier of the particular blockchain-based unit, and a quantity of the particular blockchain-based unit.

9. The computer-implemented method of claim 1, wherein the conversation includes more than two users.

10. The computer-implemented method of claim 1, the data packets are received by the computing server via an application programming interface of the messaging platform.

11. The computer-implemented method of claim 1, wherein the particular blockchain-based unit is a blockchain token, and the plurality of blockchain-based units are generated in more than one blockchain.

12. The computer-implemented method of claim 1, wherein the blockchain-based units, in one or more blockchains, are connected to one or more cryptographic public keys of the computing server through one or more blockchain addresses of the computing server, and the one or more blockchain addresses are derived from the one or more cryptographic public keys.

13. A non-transitory computer-readable medium for storing instructions, the instructions, when executed by one or more processors, cause the one or more processors to perform steps comprising:
maintaining, by a computing server, a plurality of blockchain-based units, the blockchain-based units, in one or more blockchains, connected to one or more cryptographic public keys of the computing server;
receiving, by the computing server from a messaging platform, data packets comprising one or more text messages of a conversation between at least a first user and a second user in the messaging platform;
parsing the text messages to identify (i) a text string that matches a defined action keyphrase and (ii) a particular blockchain-based unit, the text string parsed from one of the text messages transmitted from the first user to the second user;
storing new data associated with the first user, the new data reflecting a change in the particular blockchain-based unit in accordance with an action corresponding to the defined action keyphrase; and
transmitting, through the messaging platform to the first user, a confirmation of the change, wherein the particular blockchain-based unit remains connected, in one of the blockchains, to one or more of the cryptographic public keys of the computing server during storing of the new data and transmission of the confirmation, and wherein the computing server stores a plurality of user accounts, each user account including balances of one of more blockchain-based units with respect to a particular user, the blockchain-based units in each of the user accounts are connected, in the one or more blockchains, to the one or more cryptographic public keys of the computing server.

14. The non-transitory computer-readable medium of claim 13, wherein the steps further comprise:
determining that the second user does not have an account with the computing server;
creating, responsive to the determination, a new user account for the second user;
storing second new data associated with the second user, the second new data reflecting that the particular blockchain-based unit becomes associated with the second user in accordance with the action corresponding to the defined action keyphrase.

15. (canceled)

16. The non-transitory computer-readable medium of claim 15, wherein the steps further comprise:
receiving, from a third user, a request for a deposit of one of the blockchain-based units to the computing server;
generating a blockchain address based on one of the cryptographic public keys of the computing server, the blockchain address unique to the third user;
creating an association between an account of the third user and the blockchain address;
confirming a recordation of a blockchain transaction that involves the blockchain address, the blockchain transaction confirming the deposit;
changing the balance of the one of the blockchain-based units in the user account associated with the third user; and
retaining, subsequent to changing the balance, association between the user account of the third user and the blockchain address.

17. The non-transitory computer-readable medium of claim 15, wherein the steps further comprise:
receiving, from a third user, a request for a deposit of one of the blockchain-based units to the computing server;
transmitting, responsive to the request for deposit, a version of the request to a primary smart contract stored in one of the blockchain, the primary smart contract, responsive to the transmitting, generate a subsidiary smart contract;
providing, to the third user, a blockchain address of the subsidiary smart contract to the user;
creating an association between an account of the third user and the blockchain address of the subsidiary smart contract;
confirming a recordation of a blockchain transaction that involves a transfer from the user address to the blockchain address of the subsidiary smart contract; and
changing the balance of the one of the blockchain-based units in the user account associated with the third user.

18. The non-transitory computer-readable medium of claim 13, wherein the one of the text messages including the text string concerns a transfer of a quantity of the blockchain-based unit from the first user to a second user, the transfer is the action, and the new data stored includes a transaction of the quantity of the blockchain-based unit from the first user to the second user.

19. The non-transitory computer-readable medium of claim 13, wherein the messaging platform comprises a sub-application operated by the computing server, and the steps further comprise:
creating, through the sub-application, a chatroom between the first user and the computing server;
receiving an inquiring text message from the first user inquiring information of the first user's account in the computing server; and
transmitting a response text message to the first user through the chatroom, the response text message including the information inquired by the first user.

20. (canceled)
